(19) United States
(12) Patent Application Publication
(10) Pub. No.: US 2016/0136558 A1
(43) Pub. Date: May 19, 2016

(54) Article Containing Nanofiber Membrane for Bacterial Filtration

(71) Applicant: W. L. Gore & Associates, Inc., Newark, DE (US)

(72) Inventors: Lei Zheng, Newark, DE (US); Michael J. Wikol, Landenberg, PA (US); Jason J. Strid, Elkton, MD (US); Lauren Myrick, North East, MD (US)

(21) Appl. No.: 15/001,371

(22) Filed: Jan. 20, 2016

Related U.S. Application Data
(63) Continuation-in-part of application No. 14/753,479, filed on Jun. 29, 2015.
Application No. 14/753,479 is a continuation-in-part of application No. 14/336,031, filed on Jul. 21, 2014.

(51) Int. Cl. B01D 46/02

(52) U.S. Cl. CPC B01D 46/02

(57) ABSTRACT

A sterilizing grade filter including at least two non-sterile nanofiber membranes positioned in a stacked configuration is provided. The nanofiber membranes have a bubble point from about 10 psi to about 50 psi, a thickness less than about 300 microns, and a mass/area less than about 20 g/m². The non-sterile nanofiber membranes are separated from each other by a distance d, which may be less than about 100 microns. The membranes may be adhered together produce a composite stacked filtration material. Methods of producing a sterilizing grade filter are also provided.

### FIELD

The present disclosure relates generally to bacterial filtration, and more specifically, to a multilayered filtration article that meets bacterial retention requirements of a sterilizing grade filter.

### BACKGROUND

Bacterial contamination poses a threat to the safety of biopharmaceuticals, and food and beverage streams. To that end, filters have been developed to provide removal of bacteria from such process streams. Known filters that provide bacterial filtration typically employ one or more polymer (e.g., fluoropolymer) membranes. Some such filters build in a safety net and employ two layers of membranes to provide sterility assurance. That is, even if there is some passage of bacteria through the first membrane layer, the presence of the second membrane layer will presumably retain any bacteria that was not retained in the first layer. However, the flow rate of a filter is often significantly lowered with such a dual layered configuration.

In order to improve flow rate, attempts were made to use thinner membranes for this application. However small pore sizes (high bubble point) were needed to retain all the bacteria in the fluid stream so as to meet bacterial retention requirements of a sterilizing grade filter. Although high bubble points (or small pore size) membranes may have effective bacterial retention, they tend to suffer from low capacity (or throughput). Additionally, their flow rate per unit area is highly compromised and the ability to correlate bubble point and thickness to bacterial retention is lowered.

As it is desirable to improve the flow rate per unit area of filtration without compromising bacterial retention characteristics, there remains a need for a porous membrane which provides high flow rate per unit area while meeting the bacterial retention requirements of a sterilizing grade filter.

### SUMMARY

One embodiment of the invention relates to a stacked bacterial filter material that includes (1) a first non-sterile nanofiber membrane having a first major surface and a second major surface and (2) a second non-sterile nanofiber membrane positioned on the first or second major surface a distance d from the first nanofiber membrane. In one or more embodiment, at least one of the nanofiber membranes is a fluoropolymer nanofiber membrane. The distance d may be less than 100 microns. The first and second nanofiber membranes may each have a bubble point from about 10 psi to about 50 psi and a thickness less than about 300 microns. The first and second nanofiber membranes may also have a mass/area from about 0.1 g/m² to about 20 g/m². In one embodiment, the stacked bacterial filter material includes a third non-sterile nanofiber membrane. The stacked bacterial filtration material passes the Bacterial Retention Requirements for a Sterilizing Grade Filter and is a sterilizing grade filter.

A second embodiment of the invention relates to a bacterial filtration material that includes (1) a stacked filter material and (2) a first fibrous layer positioned on the stacked filter material. The bacterial filtration material is a sterilizing grade filter. The stacked filter material includes (1) a first non-sterile nanofiber membrane having a first major surface and a second major surface and (2) a second non-sterile nanofiber membrane positioned on the first major surface a distance from the first major surface. In one or more embodiment, at least one of the nanofiber membranes is a fluoropolymer nanofiber membrane. The distance d may be less than 100 microns. In addition, the first and second nanofiber membranes may each have a bubble point from about 10 psi to about 50 psi and a thickness less than about 300 microns. In at least one embodiment, a second fibrous layer is positioned on the stacked filter material on a side opposing the first fibrous layer. The stacked bacterial filtration material passes the Bacterial Retention Requirements for a Sterilizing Grade Filter and is a sterilizing grade filter.

A third embodiment of the invention relates to a bacterial filtration material that includes (1) a stacked filter material and (2) a first fibrous layer positioned on the stacked filter material. The stacked filter material includes (1) a first non-sterile nanofiber membrane having a first major surface and a second major surface and (2) a second non-sterile nanofiber membrane positioned on the first major surface a distance from the first major surface. In one or more embodiment, at least one of the nanofiber membranes is a fluoropolymer nanofiber membrane. The distance d may be less than 100 microns. In addition, the first and second nanofiber membranes may each have a bubble point from about 10 psi to about 50 psi, a thickness less than about 300 microns, and a mass/area from about 0.1 g/m² to about 20 g/m². The stacked bacterial filtration material is a sterilizing grade filter.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIG. 1 a schematic illustration of layers of material within a filtration material according to at least one embodiment of the invention;

FIG. 2 is a schematic illustration of the orientation of materials within the stacked filter material according to at least one embodiment of the invention;

FIG. 3 is an exploded view of a filtration device containing a pleated filtration medium in accordance with an embodiment of the present invention; and

FIG. 4 is a schematic illustration of a stacked filter material containing three nanofiber membranes according to at least one embodiment of the invention.

### GLOSSARY

As used herein, the term “major surface” is meant to describe the top and/or bottom surface along the length of the membrane and is perpendicular to the thickness of the membrane.

The term “fibrous layer” as used herein is meant to describe a cohesive structure of fibers which may be a woven structure, a nonwoven structure, or a knit structure.

As used herein, the term “on” is meant to denote an element, such as an expanded polytetrafluoroethylene (ePTFE) membrane or nanofiber membrane, is directly on another element or intervening elements may also be present.

As used herein, the term “adjacent” is meant to denote an element, such as an ePTFE membrane or nanofiber membrane, is directly adjacent to another element or intervening elements may also be present.

The term “substantially zero microns” is meant to define a distance that is less than or equal to 0.1 microns.

The term “nanofiber” as used herein is meant to describe a fiber having a diameter of several nanometers up to about thousands of nanometers.

The term “nanofiber membrane” as used herein is meant to describe a membrane that is formed of, or includes, nanofibers.

As used herein, the phrase “non-sterile membrane” is meant to describe an individual membrane which demonstrates at least one CFU when tested according to the Bacterial Retention Requirements for a Sterilizing Grade Filter set forth herein and thus fails the test.

As used herein, the phrase “distance between contiguous nanofiber membranes” is meant to define the distance between two nanofiber membranes that are positioned next to each other in a stacked configuration with no intervening elements or membranes therebetween.

### DETAILED DESCRIPTION

Persons skilled in the art will readily appreciate that various aspects of the present disclosure can be realized by any number of methods and apparatus configured to perform the intended functions. It should also be noted that the accompanying figures referred to herein are not necessarily drawn to scale, but may be exaggerated to illustrate various aspects of the present disclosure, and in that regard, the drawing figures should not be construed as limiting.

The present invention is directed to non-sterile nanofiber membranes that, when placed in a stacked or layered orientation, meet the stringent bacterial retention requirements for a sterilizing grade filter without significantly affecting flow rate. Individually, however, the nanofiber membranes allow bacteria to pass through. The nanofiber membrane(s) may include a fluoropolymer nanofiber membrane. The nanofiber membranes have a bubble point from about 10 psi to about 50 psi, a thickness less than about 300 microns, and a mass/area less than about 20 g/m².

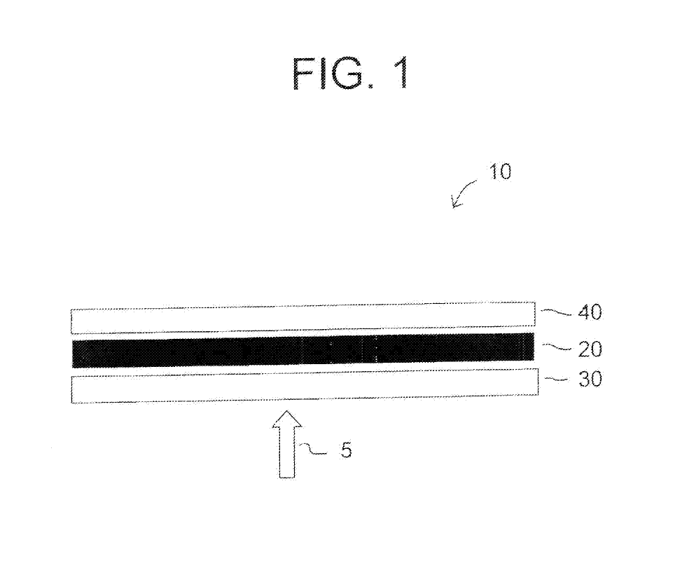

The bacterial filtration material includes at least a first layer of a stacked filter material and at least one fibrous layer that is configured to support the stacked filter material and/or is configured to provide drainage of fluid away from the stacked filter material. FIG. 1 depicts one exemplary orientation of the layers of materials forming the bacterial filtration material 10. As shown, the filtration medium 10 may include a stacked filter material 20, a first fibrous layer 30 forming an upstream drainage layer and an optional second fibrous layer 40 forming a downstream drainage layer. The arrow 5 depicts the direction of fluid flow through the filtration material.

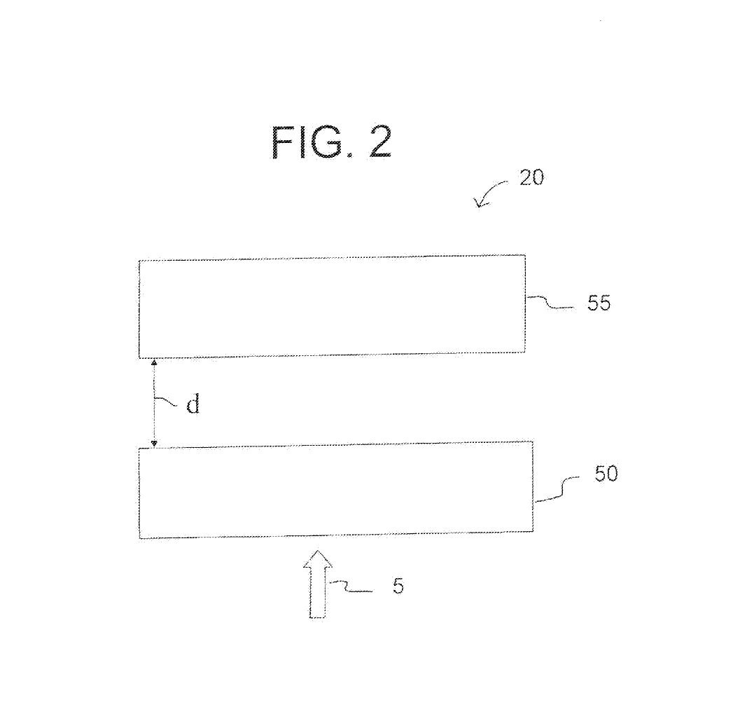

In at least one embodiment, the stacked filter material 20 contains at least two nanofiber membranes 50, 55 positioned in a stacked or layered configuration as shown generally in FIG. 2. As used herein, the term “nanofiber membrane” is meant to describe a membrane that is formed of, or includes, nanofibers. In one or more embodiment, at least one of the nanofiber membranes is a fluoropolymer nanofiber membrane. “Fluoropolymer nanofiber membrane” is meant to denote a membrane that is formed of, or includes, nanofibers of a fluoropolymer material. The term “nanofibers” describes a fiber that has a diameter of a few nanometers up to hundreds of nanometers, but not greater than about 1 micron. The diameter of the nanofiber may range from a diameter greater than zero up to about 1000 nm or a diameter greater than zero up to about 100 nm, or from about 0.001 nm to about 1000 nm, or from about 0.001 nm to about 100 nm.

The nanofibers may be formed of or include thermoplastic or thermosetting polymers and/or fluoropolymers. Additionally, the nanofibers may be electrospun nanofibers. Non-limiting examples of suitable polymers that may be utilized to form nanofibers for use in the stacked filter material 20 include, but are not limited to, polyvinylidene difluoride (PVDF), nylon, polytetrafluoroethylene (PTFE), polyurethanes, polybenzimidazole (PBI), polycarbonate (PC), polyacrylonitrile (PAN), polyvinil alcohol (PVA), polylactic acid (PLA), polyethylene-co-vinyl acetate (PEVA), poly(methacrylate) (PMA), poly(methyl methacrylate) (PMMA), polyethylene oxide (PEO), polyaniline (PAN), polystyrene (PS), polyamide (PA), polyvinylchloride (PVC), cellulose acetate, collagen, polycaprolactone (PCL), polyether imide (PEI), poly(ethylene-co-vinyl alcohol), polyvinyl pyrrolidone (PVP), polyethylene (PE), polypropylene (PP), polyethylene terephthalate (PET), polyethylene naphthalate (PEN) and combinations thereof. Additionally, the nanofibers may be hydrophilic or hydrophobic.

The nanofiber membrane 50 is positioned adjacent to or on the nanofiber membrane 55 such that material flows through the membranes 50, 55 (illustrated by arrow 5). Additionally, nanofiber membrane 50 is separated from nanofiber membrane 55 by a distance d. The distance d is the distance between contiguous nanofiber membranes (e.g., membranes 50, 55). As used herein, the phrase “distance between contiguous membranes” is meant to define the distance between two membranes that are positioned next to each other in a stacked configuration with no intervening elements or membranes therebetween. The distance d may range from about 0 microns to about 100 microns, from about 0 microns to about 75 microns, from about 0 microns to about 50 microns, or from about 0 microns to about 25 microns. In some embodiments, the distance d is zero or substantially zero microns. The distance may also be less than about 100 microns, less than about 75 microns, less than about 50 microns, less than about 25 microns, less than about 20 microns, less than about 15 microns, less than about 10 microns, less than about 5 microns, or less than about 1 micron.

The nanofiber membranes 50, 55 may be positioned in a stacked configuration by simply laying the nanofiber membranes on top of each other. Alternatively, the nanofiber membranes may be stacked and subsequently adhered together using heat and/or pressure. The stacked filtration material has a first major surface and a second major surface. Such a composite stacked filtration material may have a bubble point from about 10 psi to about 50 psi, from about 14 psi to about 20 psi, from about 21 psi to about 25 psi, from about 26 psi to about 50 psi. Alternatively, the composite stacked filtration material may have a bubble point less than about 50 psi, less than about 35 psi, less than about 30 psi, or less than about 25 psi.

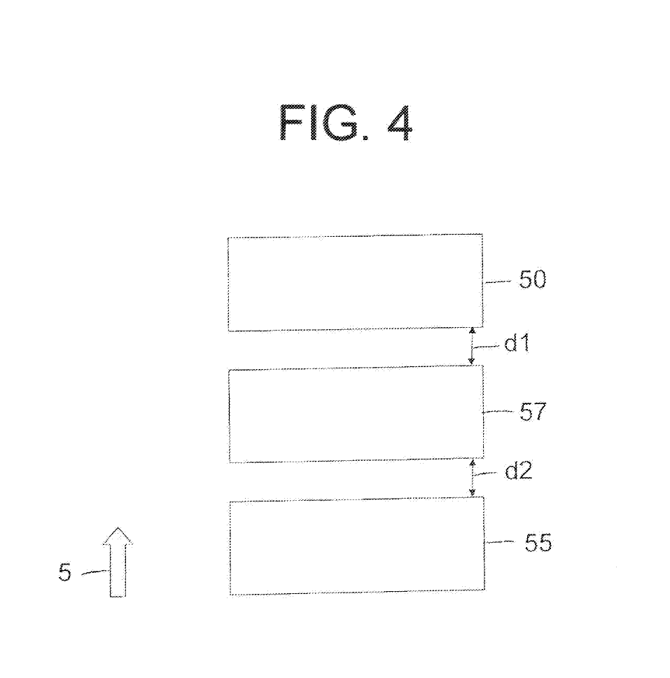

It is to be appreciated that more than two nanofiber membranes may form the stacked filter material 20. In one such embodiment depicted generally in FIG. 4, the stacked filter material 20 contains three nanofiber membranes 50, 55, and 57. The distance between nanofiber membrane 50 and nanofiber membrane 57 is designated as d1 and the distance between nanofiber membrane 57 and nanofiber membrane 55 is designated as d2. It is to be appreciated that d1 and d2 may be the same or different.

In some embodiments, the stacked filter material 20 may contain intervening layers positioned between the nanofiber membranes. For example, optional support layers may be located between the nanofiber membranes. Non-limiting examples of suitable support layers include polymeric woven materials, non-woven materials, knits, nets, nanofiber materials, and/or porous membranes, including other fluoropolymer membranes (e.g., polytetrafluoroethylene (PTFE). The support layer (not illustrated) may include a plurality of fibers (e.g., fibers, filaments, yarns, etc.) that are formed into a cohesive structure. The support layer is positioned adjacent to and downstream of the stacked filter material to provide support for the stacked filter material and a material for imbibing the nanofiber membranes 50, 55. The support layers may be a woven structure, a nonwoven structure, mesh, or a knit structure made using thermoplastic polymeric materials (e.g., polypropylene, polyethylene, or polyester), thermoset polymeric materials (e.g., epoxy, polyurethane or polyimide), or an elastomer.

The nanofiber membranes 50, 55 filter bacteria from a fluid stream when the nanofiber membranes 50, 55 are positioned in the fluid stream. It is to be appreciated that nanofiber membrane 50 and nanofiber membrane 55 individually do not meet the requirements for a sterilizing grade filter. However, when positioned in a stacked or layered configuration, such as is shown in FIG. 2, the stacked filter material 10 meets the Bacterial Retention requirements for a Sterilizing Grade Filter set forth herein.

In addition, the nanofiber membrane is thin, having a thickness from about 1 micron to about 300 microns, from about 1 micron to about 250 microns, from about 1 micron to about 200 microns, from about 1 micron to about 150 microns, from about 1 micron to about 100 microns, from about 1 micron to about 75 microns, from about 1 micron to about 50 microns, from about 1 micron to about 35 microns, from about 1 micron to about 25 microns, about 1 micron to about 20 microns, from about 1 micron to about 15 microns, from about 1 micron to about 10 microns, from about 1 micron to about 7 microns, or from about 1 micron to about 5 microns. Alternatively, the membrane has a thickness less than about 300 microns, less than about 250 microns, less than about 200 microns, less than about 150 microns, less than about 100 microns, less than about 75 microns, less than about 50 microns, less than about 35 microns, less than about 25 microns, less than about 20 microns, less than about 15 microns, less than about 10 microns, less than about 7 microns, or less than about 5 microns.

The nanofiber membranes have a mass/area from about 0.1 g/m² to about 20 g/m², from about 0.1 g/m² to about 15 g/m², from about 0.1 g/m² to 10 g/m², from about 0.1 g/m² to about 7 g/m² from about 0.1 g/m² to about 5 g/m², or from about 5 g/m² to about 10 g/m². Also, the nanofiber membranes may have an air permeability from about 0.5 Frazier to about 10 Frazier, or from about 2 Frazier to about 10 Frazier, or from about 4 Frazier to about 10 Frazier.

The bubble point of the membrane may range from about 10 psi to about 50 psi, from about 10 psi to about 40 psi, or from about 10 psi to about 25 psi Further, the nanofiber membrane (e.g., fluoropolymer nanofiber membranes) may be rendered hydrophilic (e.g., water-wettable) using known methods in the art, such as, but not limited to, the method disclosed in U.S. Pat. No. 4,113,912 to Okita, et al.

It is to be appreciated that more than two nanofiber membranes may form the stacked filter material 20. In addition, the nanofibers forming the nanofiber membranes may be derived from the same polymer, from different polymers, or a combination thereof. Also, some or all of the nanofiber membranes may vary in composition, bubble point, thickness, air permeability, mass/area, etc. from each other.

The fibrous layer in the filtration medium includes a plurality of fibers (e.g., fibers, filaments, yarns, etc.) that are formed into a cohesive structure. The fibrous layer may be positioned adjacent to and upstream and/or downstream of the stacked filter material to provide support for the stacked filter material. The fibrous layer may be a woven structure, a nonwoven structure, or a knit structure, and may be made using polymeric materials such as, but not limited to polypropylene, polyethylene or polyester.

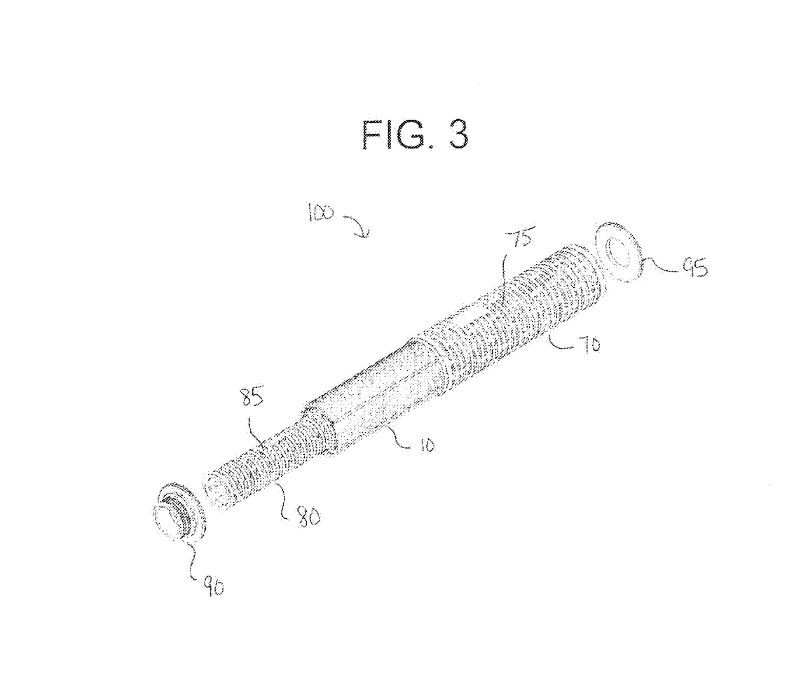

Turning to FIG. 3, the filtration medium 10 may be concentrically disposed within an outer cage 70. The outer cage 70 that has a plurality of apertures 75 through the surface of the outer cage 70 to enable fluid flow through the outer cage 70, e.g., laterally through the surface of the outer cage 70. An inner core member 80 is disposed within the cylindrical filtration medium 10. The inner core member 80 is also substantially cylindrical and includes apertures 85 to permit a fluid stream to flow through the inner core member 80, e.g., laterally through the surface of the inner core member 80. Thus, the filtration medium 10 is disposed between the inner core member 80 and the outer cage 70. The filtration article 100 may be sized for positioning within a filtration capsule (not illustrated).

The filtration device 100 further includes end cap components 90, 95 disposed at opposite ends of the filtration cartridge 100. The end cap components 90, 95 may include apertures (not illustrated) to permit fluid communication with the inner core member 80. Thus, fluid may flow into the filtration cartridge 100 through the apertures and into the inner core member 80. Under sufficient fluid pressure, fluid will pass through apertures 85, through the filtration medium 10, and exit the filtration cartridge 100 through the apertures 75 of the outer cage 70.

When the filtration cartridge 100 is assembled, the end cap components 90, 95 are potted onto the filtration medium 10 with the outer cage 70 and the inner core member 80 disposed between the end cap components 90, 95. The end cap components 90, 95 may be sealed to the filtration medium 10 by heating the end cap components 90, 95 to a temperature that is sufficient to cause the thermoplastic from which the end cap components are fabricated to soften and flow. When the thermoplastic is in a flowable state, the ends of the filtration medium 10 are contacted with the respective end cap components 90, 95 to cause the flowable thermoplastic to imbibe (e.g., to infiltrate) the filtration medium 10. Thereafter, the end cap components 90, 95 are solidified (e.g., by cooling) to form a seal with the filtration medium 10. The assembled filtration cartridge 100 (e.g., with the end cap components potted onto the filtration medium) may then be used in a filtration device such as a filtration capsule. One or both ends of the stacked filtration member 20 and fibrous layers 30, 60 of filtration article 100 may be potted to sealably interconnect the end(s) of the filtration medium 10.

It is to be appreciated that various other configurations of filtration devices may be utilized in accordance with the present disclosure, such as non-cylindrical (e.g., planar) filtration devices. Further, although the flow of fluid is described as being from the outside of the filtration cartridge to the inside of the filtration cartridge (e.g., outside-in flow), it is also contemplated that in some applications fluid flow may occur from the inside of the filtration cartridge to the outside of the filtration cartridge (e.g., inside-out flow).

Persons skilled in the art will readily appreciate that various aspects of the present disclosure can be realized by any number of methods and apparatus configured to perform the intended functions. It should also be noted that the accompanying drawing figures referred to herein are not necessarily drawn to scale, but may be exaggerated to illustrate various aspects of the present disclosure, and in that regard, the drawing figures should not be construed as limiting.

### Test Methods

It should be understood that although certain methods and equipment are described below, other methods or equipment determined suitable by one of ordinary skill in the art may be alternatively utilized.

Bubble Point

The bubble point was measured according to the general teachings of ASTM F31 6-03 using a Capillary Flow Porometer (Model CFP 1500 AE from Porous Materials, Inc., Ithaca, N.Y.). The sample membrane was placed into a sample chamber and wet with SilWick Silicone Fluid (commercially available from Porous Materials, Inc.) having a surface tension of 19.1 dynes/cm. The bottom clamp of the sample chamber consists of a 40 micron porous metal disc insert (Mott Metallurgical, Fannington, Conn.) with the following dimensions (2.54 cm diameter, 3.175 mm thickness). The top clamp of the sample chamber consists of an opening, 12.7 mm in diameter. Using the Capwin software version 6.74.70, the following parameters were set as specified in Table 1. The values presented for bubble point were the average of two measurements.

TABLE 1

| Parameter Set Point | Set Point |
|---|---|
| Maxflow (cc/m) | 200000 |
| Bubflow (cc/m) | 38 |
| F/PT | 50 |
| Minbppres (psi) | 0.1 |
| Zerotime (sec) | 1 |
| V2incr (cts) | 10 |
| Preginc (cts) | 1 |
| Pulse Delay (sec) | 2 |
| Maxpress (psi) | 500 |
| Pulse Width (sec) | 0.2 |
| Mineqtime (sec) | 30 |
| Presslew (cts) | 10 |
| Flowslew (cts) | 50 |
| Eqiter (0.1 sec) | 3 |
| Aveiter (0.1 sec) | 20 |
| Maxpdif (psi) | 0.1 |
| Maxfdif (cc/m) | 50 |
| Startp (psi) | 1 |

Mass Per Area (Mass/Area)

The mass/area of the membrane was calculated by measuring the mass of a well-defined area of the sample using a scale. The sample was cut to a defined area using a die or any precise cutting instrument.

Frazier Air Permeability

Air flow was measured using the TexTest Model FX3310 instrument. The air flow rate through the sample was measured and recorded. The Frazier Air Permeability is the rate of flow of air in cubic feet per square foot of sample area per minute when the differential pressure drop across the sample is 12.7 mm (0.5 inch) water column.

Membrane Thickness Using Scanning Electron Micrograph (SEM)

Membranes were sectioned using a cold single-sided razor blade. The sections were mounted on an aluminum SEM stub with conductive double-sided carbon tape. Sections were approximately 5 mm in length. Images were acquired at magnifications of 5000× and 10,000×, a working distance of 3-5 mm, and an operating voltage of 2 kV on a Hitachi® SU-8000 Field Emission Scanning Electron Microscope (FE-SEM). Images were recorded at a data size of 2560×1920. Point-to-point thickness measurements of features of interest on the images were measured and recorded using Quartz Imaging® PCI software. The MRS-4 calibration standard (Geller MicroAnalytical Laboratory) was to calibrate the FESEM.

Bacterial Retention Test Method

(A) Brevundimonas diminuta Challenge Suspension Preparation

The general methods described in ASTM F838-05 and PDA TR No. 26 were followed. In particular, a bacterial suspension was prepared using lyophilized Brevundimonas diminuta (ATCC® 19146™ from American Type Culture Collection, Manassas, Va.). The lyophilized B. diminuta were re-hydrated with 10 mL of sterile Trypticase Soy Broth (TSB), procured from Becton Dickinson, Sparks, Md. The entire solution was incubated at 30±2° C. for 24 hours.

After incubation was complete, eighty Trypticase Soy Agar (TSA) slants were inoculated, each with 75 micro liter of the above TSB culture. The TSA slants were incubated at 30±2° C. for 48 hours and then stored at −80° C. The TSA slants serve as the seed bacteria for use in the bacterial retention test and can be stored at −80° C. for as long as one year.

One of the stored TSA slants was thawed and re-suspended in 5 mL sterile TSB. The TSA slant solution was then inoculated with 200 mL additional sterile TSB aseptically and then incubated at 30±2° C. for 24 hours.

18 mL TSB culture was inoculated into 4.5 L of sterile Saline Lactose Broth (SLB) procured from Becton Dickinson, Sparks, Md. The SLB culture was set up on the magnetic stirrer inside an incubator and connected to sterile air supply. This culture was incubated at 30±2° C. for 24 hours.

The final bacterial challenge suspension was prepared by adding sterile SLB as a diluent to the culture to reach the desired bacteria concentration of at least 10⁷ CFU/cm² The concentration of viable bacteria in the challenge suspension was determined by performing serial dilution and plating via a spread plate method on TSA plates.

(B) Filtration Test Procedure

A 47 mm disk of a polypropylene non-woven material was placed on top of the metal screen of a filter holder (Part No. DH1-047-10-S, Meissner Filter Products, Camarillo, Calif.). An open ePTFE membrane (i.e., less than about 3 psi in Bubble Point) was placed on top of the non-woven material to protect subsequent nanofiber membranes from mechanical damage. The nanofiber membrane sample was placed on top of the open ePTFE membrane without wrinkles. The filter holder was then tightened with clamps. A 0.45 μm polyvinylidene difluoride (PVDF) hydrophilic membrane was used for the positive control membrane as part of the test procedure.

Three pressurized vessels were loaded with the bacterial challenge solution. SLB rinse, and IPA respectively. Transfer lines, air tubes, valves and calibrated gas gauges were connected to the vessels aseptically. The pressure was set up at 30 psig throughout the test system and all three transfer lines out of the three pressurized vessels were primed by controlling valves. The filter holder was connected to the challenge suspension vessel.

When nanofiber membranes were tested the membranes were pre-wetted with about 200 mL of 70% IPA followed by a 600 mL sterile SLB rinse.

At a differential pressure of 30 psid across the sample, the bacterial challenge solution was filtered through the membrane sample. About 160 mL of the filtrate was collected in a 500 mL sterile sample bottle and passed under vacuum through an assay filter assembly consisting of a hydrophilic cellulose acetate membrane of rated pore size 0.45 micron. (Part No. MVHAWGS24, Millipore, Billerica, Mass.). The assaying membrane was then removed from the assembly and placed on a TSA plate.

The plate was placed in the incubator at 30±2° C. for at least 48 hours. After 48 hours B. diminuta colonies had grown on the TSA plates. The bacteria colonies were counted as colony forming units (CFU) and recorded.

(C) Bacterial Retention Requirements for a Sterilizing Grade Filter

Three nanofiber membrane samples were tested according to the Bacterial Retention Test Procedure. The nanofiber membranes were determined to meet the bacterial retention requirements of a sterilizing grade filter only when all of the three samples recorded 0 (zero) CFU. If one CFU is recorded, the ePTFE membrane sample failed and did not meet the requirements for a sterilizing grade filter.

### EXAMPLES

### Example 1

Two nanofiber layers (Part No: F4200, Finetex Corporation) constructed using hydrophilic polyvinylidene difluoride (PVDF), with each layer having a Bubble Point of 19.9 psi, an Air permeability of 0.64 Frazier, a thickness of 8.6 microns, and mass per area of 6 g/m², were placed on top of each other in a layered or stacked configuration to form a two-layered stacked filter. The stacked filter had an increased Bubble Point of 21.3 psi. The air permeability of the stacked filter was measured to be 0.32 Frazier. The properties of both the single layer and the stacked filter are shown in Table 2.

The two-layered stacked filter was tested in accordance with the Bacterial Retention Test Method set forth herein. Zero CFUs were detected. Thus, the stacked filter was determined to meet bacterial retention requirements of a sterilizing grade filter.

### Comparative Example 1

A single nanofiber layer from the previous Example was tested in accordance with the Bacterial Retention Test Method set forth herein. At least one CFU was detected. Thus, a single nanofiber layer of the Example did not meet the bacterial retention requirements of a sterilizing grade filter. The results are set forth in Table 2.

### Example 2

Nanofiber layers were made by electrospinning using the free surface technique described in US 20080307766 A1 using an Elmarco NS lab 500S machine (Elmarco Sro, Liberec, Czech Republic). For these experiments a 6 inch bath with a 4 wire spinning electrode was used. Nanofiber mats were collected on a 6×6 inch square ⅛ inch thick stainless steel plates connected to the machines collecting electrode wire.

A solution was made from Nylon 6 polymer supplied by BASF Corp. Florham Park, N.J., USA, under the trademark Ultramid B24. The stock spinning solution was prepared by stirring Nylon in a mixture of acetic and formic acids (2:1 weight ratio) for 5 hr at 80° C. The polymer solids were 20% of the stock solution. The solution was then further diluted to 13 wt % and a 2:2:1 formic:acetic:water concentration using formic acid and water, respectively.

The viscosity of the resulting solution is about 100 cP. The bath was charged with 40 mL of spinning solution and the spinning electrode bath was cleaned and replaced for each new replicate sample. The solution was immediately spun using the 4-Wire spinning electrode under 82 kV electric field at a separation distance of 155 mm. The spinning electrode rotation was set at 10 rpm. Relative humidity was held constant at 31% rH by blending dry nitrogen with house air. The sample was collected after 5 minutes of spun time.

The nanofiber sample produced above having a bubble point of 22.3 psi, an air permeability of 1.27 Frazier, a thickness of 7.1 microns, and mass per area of 2.6 g/m², were placed on top of each other in a layered or stacked configuration to form a two-layered stacked filter. The stacked filter had an increased bubble point of 44.6 psi. The air permeability of the stacked filter was measured to be 0.64 Frazier. The properties of both the single layer and the stacked filter are shown in Table 2.

The two-layered stacked filter was tested in accordance with the Bacterial Retention Test Method set forth herein. Zero CFUs were detected. Thus, the stacked filter was determined to meet bacterial retention requirements of a sterilizing grade filter.

### Comparative Example 2

A single nanofiber layer from the previous Example 2 was tested in accordance with the Bacterial Retention Test Method set forth herein. At least one CFU was detected. Thus, a single nanofiber layer of the Example did not meet the bacterial retention requirements of a sterilizing grade filter. The results are set forth in Table 2.

TABLE 2

| | | | | | Bacterial |
|---|---|---|---|---|---|
| | | | | | Retention |
| | | | | | To Meet |
| | | | | | Sterilization |
| | Bubble | | | | Filter Grade |
| | Point | Mass/Area | Thickness | | Requirements |
| | (psi) | (g/m²) | (micron) | Frazier | (Yes/No) |
| Example 1 | 19.9* | 6 | 8.6* | 0.64* | Yes |
| | 21.3** | | 17.2** | 0.32** | |
| Comparative | 19.9 | 6 | 8.6 | 0.64 | No |
| Example 1 | | | | | |
| Example 2 | 22.3* | 2.6 | 7.1* | 1.27* | Yes |
| | 44.6** | | 14.2** | 0.64** | |
| Comparative | 22.3 | 2.6 | 7.1 | 1.27 | No |
| Example 2 | | | | | |

*indicates single layer filter measurements
**indicates 2-layer stacked filter measurements

The invention of this application has been described above both generically and with regard to specific embodiments. It will be apparent to those skilled in the art that various modifications and variations can be made in the embodiments without departing from the scope of the disclosure. Thus, it is intended that the embodiments cover the modifications and variations of this invention provided they come within the scope of the appended claims and their equivalents.

What is claimed is:

1. A stacked bacterial filter material comprising:
a first non-sterile nanofiber membrane having a first major surface and a second major surface; and
a second non-sterile nanofiber membrane positioned on one of said first major surface and second major surface a first distance from said first fluoropolymer membrane,
wherein said distance is less than 100 microns,
wherein said first and second membranes each have a bubble point from about 10 psi to about 50 psi,
wherein said first and second membranes each have a thickness less than about 300 microns, and
wherein said stacked bacterial filtration material passes the Bacterial Retention Requirements for a Sterilizing Grade Filter.

2. The stacked bacterial filter material of claim 1, wherein at least one of said first and second nanofiber membranes is a fluoropolymer nanofiber membrane.

3. The stacked bacterial filter material of claim 1, wherein at least one of said first and second nanofiber membranes comprises a polymer selected from polyvinylidene difluoride (PVDF), nylon, polytetrafluoroethylene (PTFE), polyurethanes, polybenzimidazole (PBI), polycarbonate (PC), polyacrylonitrile (PAN), polyvinyl alcohol (PVA), polylactic acid (PLA), polyethylene-co-vinyl acetate (PEVA), poly(methacrylate) (PMA), poly(methyl methacrylate) (PMMA), polyethylene oxide (PEO), polyaniline (PAN), polystyrene (PS), polyamide (PA), polyvinylchloride (PVC), cellulose acetate, collagen, polycaprolactone (PCL), polyether imide (PEI), poly(ethylene-co-vinyl alcohol), polyvinyl pyrrolidone (PVP), polyethylene (PE), polypropylene (PP), polyethylene terephthalate (PET), polyethylene naphthalate (PEN) and combinations thereof.

4. The stacked bacterial filter material of claim 1, wherein said first and second nanofiber membranes each have a mass/area from about 0.1 g/m² to about 20 g/m².

5. The stacked bacterial filter material of claim 1, wherein said first and second nanofiber membranes form a composite stacked filtration material.

6. The stacked bacterial filter material of claim 5, wherein composite stacked filtration material has a bubble point from about 10 psi to about 50 psi.

7. The stacked bacterial filter material of claim 1, further comprising a third non-sterile nanofiber membrane having a first major surface and a second major surface,
wherein said first non-sterile nanofiber membrane, said second non-sterile nanofiber membrane, and said third non-sterile nanofiber membrane are positioned a distance from each other, said distance being less than 100 microns.

8. The stacked bacterial filter material of claim 1, wherein said first and second nanofiber membranes each have a bubble point from about 10 psi to about 50 psi.

9. A bacterial filtration material comprising:
a stacked filter material comprising:
a first non-sterile nanofiber membrane having a first major surface and a second major surface; and
a second non-sterile nanofiber membrane positioned on said first major surface a distance from said first major surface, and
a first fibrous layer positioned on said stacked filter material,
wherein said distance is less than 100 microns,
wherein said first and second non-sterile nanofiber membranes each have a bubble point from about 10 psi to about 50 psi,
wherein said first and second nanofiber membranes each have a thickness less than about 300 microns, and
wherein said stacked bacterial filtration material passes the Bacterial Retention Requirements for a Sterilizing Grade Filter.

10. The stacked bacterial filter material of claim 9, wherein at least one of said first and second nanofiber membranes is a fluoropolymer nanofiber membrane.

11. The stacked bacterial filter material of claim 9, wherein at least one of said first and second nanofiber membranes comprises a polymer selected from polyvinylidene difluoride (PVDF), nylon, polytetrafluoroethylene (PTFE), polyurethanes, polybenzimidazole (PBI), polycarbonate (PC), polyacrylonitrile (PAN), polyvinyl alcohol (PVA), polylactic acid (PLA), polyethylene-co-vinyl acetate (PEVA), poly(methacrylate) (PMA), poly(methyl methacrylate) (PMMA), polyethylene oxide (PEO), polyaniline (PAN), polystyrene (PS), polyamide (PA), polyvinylchloride (PVC), cellulose acetate, collagen, polycaprolactone (PCL), polyether imide (PEI), poly(ethylene-co-vinyl alcohol), polyvinyl pyrrolidone (PVP), polyethylene (PE), polypropylene (PP), polyethylene terephthalate (PET), polyethylene naphthalate (PEN) and combinations thereof.

12. The bacterial filtration material of claim 9, further comprising a second fibrous layer positioned on said stacked filter material on a side opposing said first fibrous layer.

13. The bacterial filtration material of claim 9, wherein said first and second non-sterile nanofiber membranes each have a thickness less than about 25 microns.

14. The stacked bacterial filter material of claim 9, wherein said first and second non-sterile nanofiber membranes each have a mass/area from about 0.1 g/m² to about 20 g/m².

15. The stacked bacterial filter material of claim 9, wherein said distance is substantially zero microns.

16. The stacked bacterial filter material of claim 9, wherein said first and second non-sterile nanofiber membranes are adhered to each other.

17. The stacked bacterial filter material of claim 9, wherein said first and second non-sterile nanofiber membranes form a composite stacked filtration material.

18. The stacked bacterial filter material of claim 17, wherein said composite stacked filtration material has a bubble point from about 10 psi to about 50 psi.

19. A stacked bacterial filter material comprising:
a stacked filtration material comprising a first non-sterile nanofiber membrane and a second non-sterile nanofiber membrane, said stacked filtration material having a first major surface and a second major surface,
wherein said first and second non-sterile nanofiber membranes are positioned a distance less than 100 microns from each other,
wherein said stacked filtration material has a bubble point from about 10 psi to about 50 psi, and
wherein said first and second non-sterile nanofiber membranes each have a thickness less than about 300 microns, and
wherein said stacked bacterial filtration material passes the Bacterial Retention Requirements for a Sterilizing Grade Filter.

20. The stacked bacterial filter material of claim 19, wherein at least one of said first and second nanofiber membranes is a fluoropolymer nanofiber membrane.

21. The stacked bacterial filter material of claim 19, wherein at least one of said first and second nanofiber membranes comprises a polymer selected from polyvinylidene difluoride (PVDF), nylon, polytetrafluoroethylene (PTFE), polyurethanes, polybenzimidazole (PBI), polycarbonate (PC), polyacrylonitrile (PAN), polyvinyl alcohol (PVA), polylactic acid (PLA), polyethylene-co-vinyl acetate (PEVA), poly(methacrylate) (PMA), poly(methyl methacrylate) (PMMA), polyethylene oxide (PEO), polyaniline (PAN), polystyrene (PS), polyamide (PA), polyvinylchloride (PVC), cellulose acetate, collagen, polycaprolactone (PCL), polyether imide (PEI), poly(ethylene-co-vinyl alcohol), polyvinyl pyrrolidone (PVP), polyethylene (PE), polypropylene (PP), polyethylene terephthalate (PET), polyethylene naphthalate (PEN) and combinations thereof.

22. The stacked bacterial filter material of claim 19, wherein said first and second non-sterile nanofiber membranes are adhered to form said composite stacked filtration material.

23. The stacked bacterial filter material of claim 19, wherein said first and second non-sterile nanofiber membranes each have a mass/area from about 0.1 g/m² to about 20 g/m².
